(19) United States
(12) Patent Application Publication
(10) Pub. No.: US 2009/0265385 A1
(43) Pub. Date: Oct. 22, 2009

(54) INSURANCE DOCUMENT IMAGING AND PROCESSING SYSTEM

(76) Inventors: Paula M. Beland, Simsbury, CT (US); Vittoria Pace, Glastonbury, CT (US); Sandra J. Meyerhofer, Rocky Hill, CT (US); Catherine Carillo, Bloomfield, CT (US); Karen B. Weiss, Scottsdale, AZ (US)

Correspondence Address: BUCKLEY, MASCHOFF & TALWALKAR LLC, 50 LOCUST AVENUE, NEW CANAAN, CT, 06840, US

(21) Appl. No.: 12/105,659

(22) Filed: Apr. 18, 2008

(51) Int. Cl. G06Q 40/00; G06F 17/30

(52) U.S. Cl. 707/104.1; 705/4; 707/E17.044

(57) ABSTRACT

According to some embodiments, an insurance document is received at a document conversion system. The received document may be converted to a document image, and document identification data may be assigned to the document image. The assigned document identification data may be automatically matched to (and/or associated with) insurance information. It may then be arranged to provide the document image, the insurance information, and/or the document identification data for review. Subsequent to review, an insurance claim may be processed in accordance with the document image, the insurance information, and/or the document identification data.

### BACKGROUND

An insurance company may receive a large number of insurance documents related to insurance claims. For example, a property and casualty insurance company might receive tens of thousands of documents each day in various ways (e.g., via postal mail, facsimile machines, and email). Moreover, the insurance company will typically receive many different types of documents (e.g., bills, accident reports, and claim forms) and those documents will be received from various types of parties (e.g., claimants, hospitals, and other insurance companies).

For each received document, the insurance company might need to associate the document with an appropriate insurance event, and/or claim in order process it correctly. Because so many different types of documents are received from so many different parties, however, many documents will include some information (e.g. a party name and a date of loss) without referencing an appropriate insurance policy, event, or claim number. Moreover, various documents associated with a single event or claim may need to be collected together in order to be processed in an orderly fashion. Such actions can be time consuming, error prone, and difficult to administer in a cost effective basis, especially when a substantial numbers of documents and insurance claims are involved.

### BRIEF DESCRIPTION OF THE DRAWINGS

FIG. 1 is block diagram of a system according to some embodiments of the present invention.

FIG. 2 illustrates a method according to some embodiments of the present invention.

FIG. 3 is a block diagram of a document conversion system in accordance with some embodiments of the invention.

FIG. 4 illustrates a document conversion system display in accordance with some embodiments of the invention.

FIG. 5 illustrates an automated matching platform or engine in accordance with an exemplary embodiment of the invention.

FIG. 6 is a tabular view of a portion of an insurance policy database in accordance with some embodiments of the present invention.

FIG. 7 is a tabular view of a portion of an insurance event database in accordance with some embodiments of the present invention.

FIG. 8 is a tabular view of a portion of a document image database in accordance with some embodiments of the present invention.

FIG. 9 is a block diagram illustrating how insurance data might be transmitted to reviewers in accordance with some embodiments of the present invention.

FIGS. 10A and 10B illustrate an automated matching method according to some embodiments of the present invention.

FIGS. 11 through 17 illustrate some graphical user interface displays in accordance with an exemplary embodiment of the present invention.

### SUMMARY OF THE INVENTION

According to some embodiments, an insurance document is received at a document conversion system. The received document may be converted to a document image, and document identification data may be assigned to the document image. The assigned document identification data may be automatically matched to (and/or associated with) insurance information. It may then be arranged to provide the document image and the insurance information for review. Subsequent to review, an insurance claim may be processed in accordance with the document image, the insurance information, and/or the document identification data.

Other embodiments include: means for receiving an insurance document at a document conversion system; means for converting, via the document conversion system, the received insurance document to a document image; means for assigning document identification data to the document image; means for automatically matching, via a computer-implemented method, the assigned document identification data to insurance information, storing the insurance information, and associating the insurance information with the document image; means for arranging to provide the document image and the insurance information for review; and means for processing, subsequent to said review, an insurance claim in accordance with at least one of the document image, the insurance information, or the document identification data.

In some embodiments, a communication device associated with an automated matching platform or engine exchanges information with remote devices. The information may be exchanged, for example, via public and/or proprietary communication networks.

A technical effect of some embodiments of the invention is an automated facilitation insurance document processing. With this and other advantages and features that will become hereinafter apparent, a more complete understanding of the nature of the invention can be obtained by referring to the following detailed description and to the drawings appended hereto.

### DETAILED DESCRIPTION

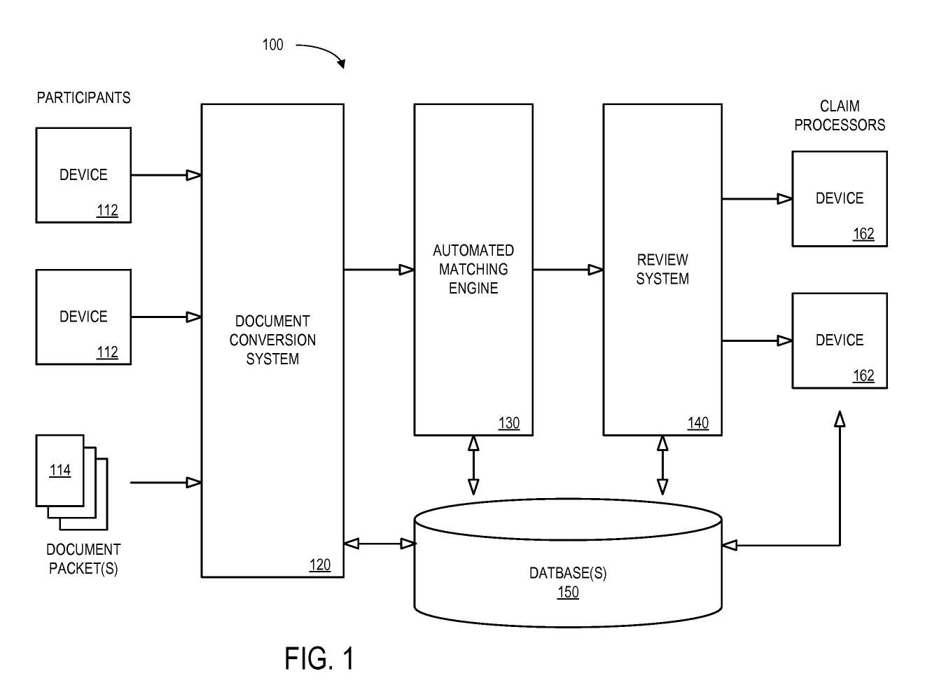

FIG. 1 is block diagram of an integrated document processing system 100 according to some embodiments of the present invention. The system 100 may, for example, facilitate the handling and processing of insurance documents that are received from participants. As used herein, the phrase “insurance document” may refer to, for example, electronic or paper representations of information associated with an insurance policy, event, or claim. By way of example, an insurance document might be a medical document (e.g., from a doctor or hospital), a law enforcement document (e.g., a police accident report or speeding ticket), a billing document (e.g., from medical service provider or a repair shop), a legal proceeding document (e.g., associated with a civil, criminal, or arbitration proceeding), or an insurance policy document (e.g., from another insurance company). Additionally note that the word “document” as used herein can refer to other types of information, including photographs, video images, and/or audio recordings associated with an insurance event or claim.

Moreover, as used herein the term “participant” may refer to any person or entity that provides insurance documents to the system 100. By way of example only, a participant could be an insurance claimant or agent, a medical or other service provider, or another insurance company.

Participants might provide insurance documents from remote devices 112 via a communication network. The devices 112 could comprise, for example, facsimile machines, email servers, and/or web servers. Note that any of the devices described herein might comprise a Personal Computer (PC), a portable computing device such as a Personal Digital Assistant (PDA), or any other appropriate storage and/or communication device to exchange insurance-related information via a web site and/or a communication network. As used herein, devices (including the participant devices 112) may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

According to some embodiments, participants might also send insurance documents to the system via postal mail or any other document delivery system. For example, all mail addressed to a particular Post Office box might be delivered to, and be handled by, the system 100. Also note that the system 100 may receive document “packets” 114 from participants. For example, a received document packet 114 might represent an envelope that contained a number of separate pages or “sub-documents.”

According to some embodiments, the insurance documents provided by participants and/or the remote devices 112 are received by or at a document conversion system 120. The document conversion system 120 may, for example, convert each received document into a document image (e.g., an electronic file representing the insurance document). The document conversion system 120 may also assign document identification data to the document image. For example, the document conversion system 120 might assign a claimant name, address, and date of loss to the document image.

The document conversion system 120 may provide the document image and assigned document identification data to an automated matching engine 130. Note that some or all of the elements described with respect to the present invention might be “automated.” As used herein, the term “automated” indicates that at least some part of a step associated with a process or service is performed with little or no human intervention. The automated matching engine 130 might, for example, match the document image with insurance information (e.g. by matching the image with an appropriate insurance policy number, insurance event number, and/or insurance claim number).

According to some embodiments, the automated matching engine 130 provides the document image and associated insurance information to a review system 140. The review system 140 may, for example, arrange for a manual review of the document image, the insurance information, and/or the document identification data. For example, a reviewer might alter or annotate insurance information after looking at the document image.

Note that document conversion system 120, automated matching engine 130, review system 140, and/or any of the other devices described herein might communicate directly (e.g., via an email message attachment or a file transfer) or through one or more databases 150. For example, the document conversion system 120 might store an image file (or a link or pointer to the image file) in the databases 150. The automated matching engine 130 and/or review system 140 could then access the image file via the databases 150.

According to some embodiments, the image files and associated insurance information may be accessed by one or more remote claim processor devices 162. For example, an employee of an insurance company might review the image file and associated insurance information (e.g. from the databases 150) when handling an automobile insurance claim. Note that embodiments of the present invention may be used with desirable results in a number of different claim processing environments. For example, embodiments may be used to process and create new insurance claims, such as claims under auto, life, property, or workers compensation policies. For simplicity, and ease of exposition, embodiments will be described using an illustrative (but not limiting) example relating to the creation of a new claim under an automobile policy. Those skilled in the art will recognize that features described in the illustrative example may be used to desirable advantage in other claim processing situations.

Although a single document conversion system 120, automated matching engine 130, and review system 140 are shown in FIG. 1, any number of such systems may be included. Similarly, any number of participant devices 112 and claim processor devices 162 (and any other devices described herein) may be included and/or combined according to embodiments of the present invention. For example, in some embodiments, the document conversion system 120 and automated matching engine 130 might be co-located and/or may comprise a single apparatus.

In an illustrative example, an integrated claim processing system pursuant to the present invention is utilized by an insurance company that issues automobile insurance policies. A policy has been issued to a customer named Jane Doe. In order for Jane Doe to make a claim after an accident, she must contact her insurance company and provide the appropriate documents before the company can approve her claim. In this case, she might mail documents associated with her claim to the document conversion system 120. In addition, her doctor might fax a copy of her medical bill to the document conversion system 120. Note that the medical bill might include her name and date of treatment, but lack any indication of her insurance policy number or other identifiers associated with her particular claim.

In this case, the document conversion system 120 might scan the paper documents to create image files. Moreover, operators working at the document conversion system 120 might manually enter whatever information is available from those documents (e.g., her name and date of treatment from the medical bill). This information can be provided to the automated matching engine 130 which, using information stored in the databases 150, determines the appropriate insurance claim number that should be associated with the documents. In this way, claim processors will have that information available via the devices 162 when reviewing and approving her claim.

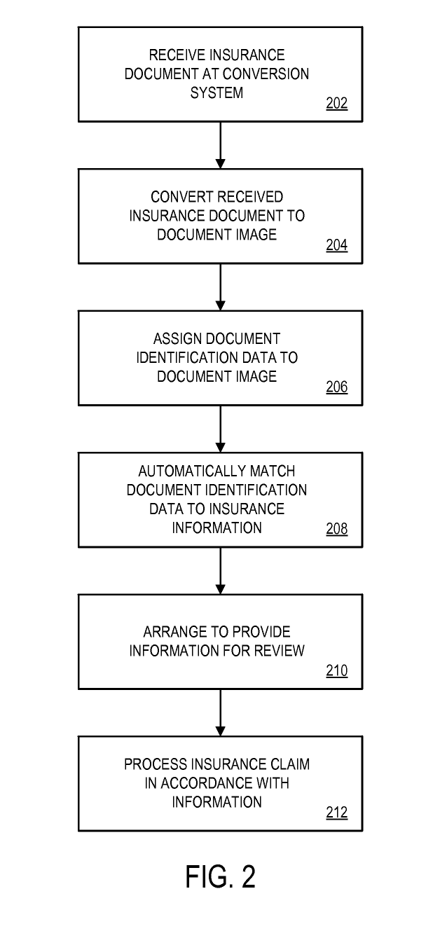

FIG. 2 illustrates a method that might be performed, for example, by some or all of the elements of the system 100 described with respect to FIG. 1 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a storage medium may store thereon instructions that when executed by a machine result in performance according to any of the embodiments described herein.

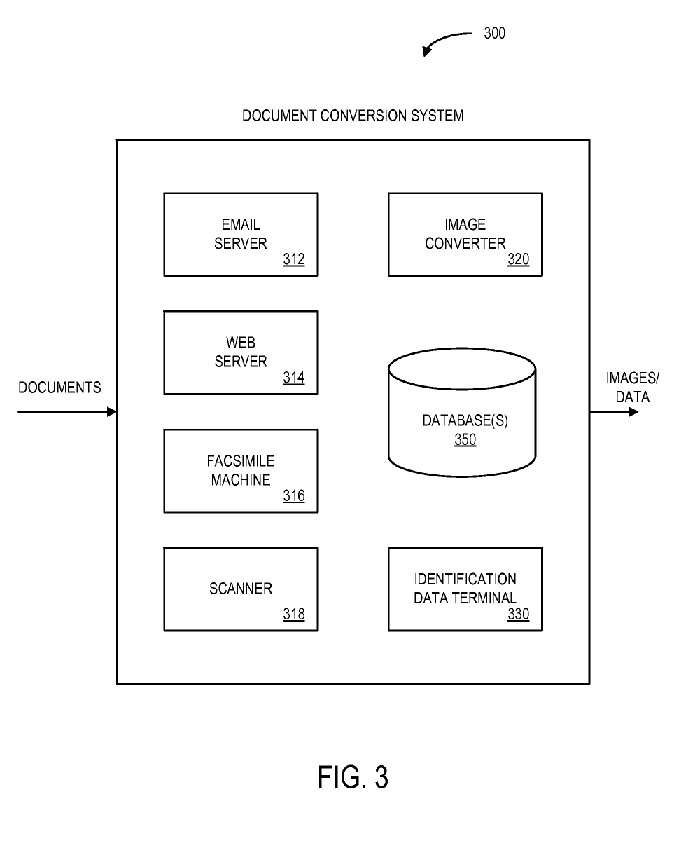

At 202, an insurance document is received at a document conversion system. For example, the document conversion system might receive tens of thousands of insurance documents from various participants each day. One example of such a document conversion system is described herein with respect to FIG. 3.

At 204, the received document is converted into a document image. For example, an automated application at the document conversion system might translate received fax signals into an electronic image file. In some cases, paper documents might be scanned and converted into image files.

At 206, document identification data is assigned to the document image. The document identification data might include, for example, a claimant name, address, and contact information. Other examples of document identification data might include a date of loss, a date of service, a claim type, and/or a geographic location (e.g., a state where an insurance policy was issued or where an insurance claim arose). The assignment of document identification data might be performed, for example, manually via a graphical user interface and/or using an optical character recognition process.

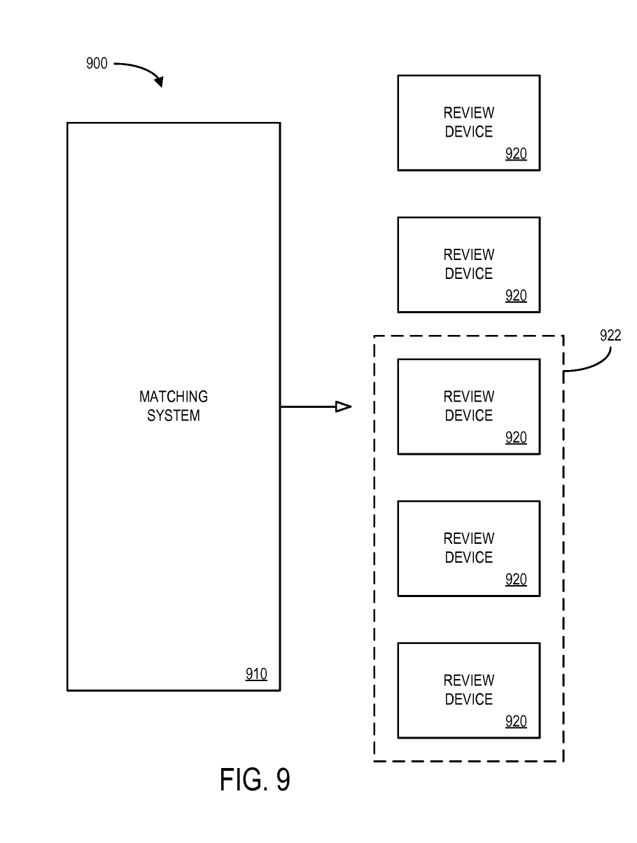

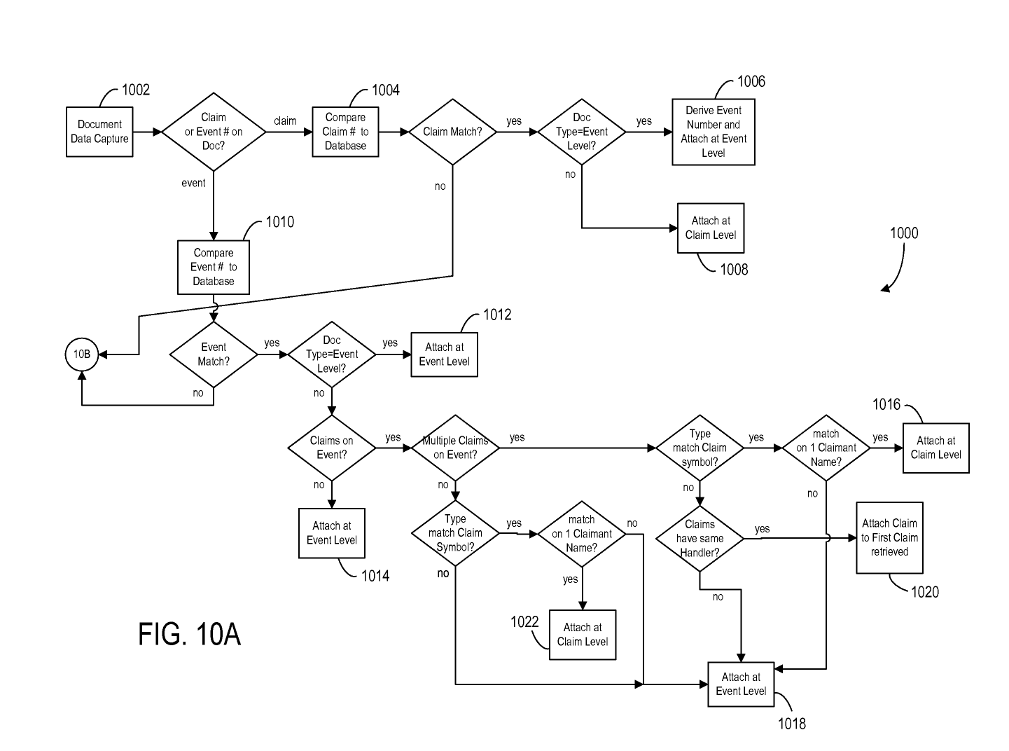

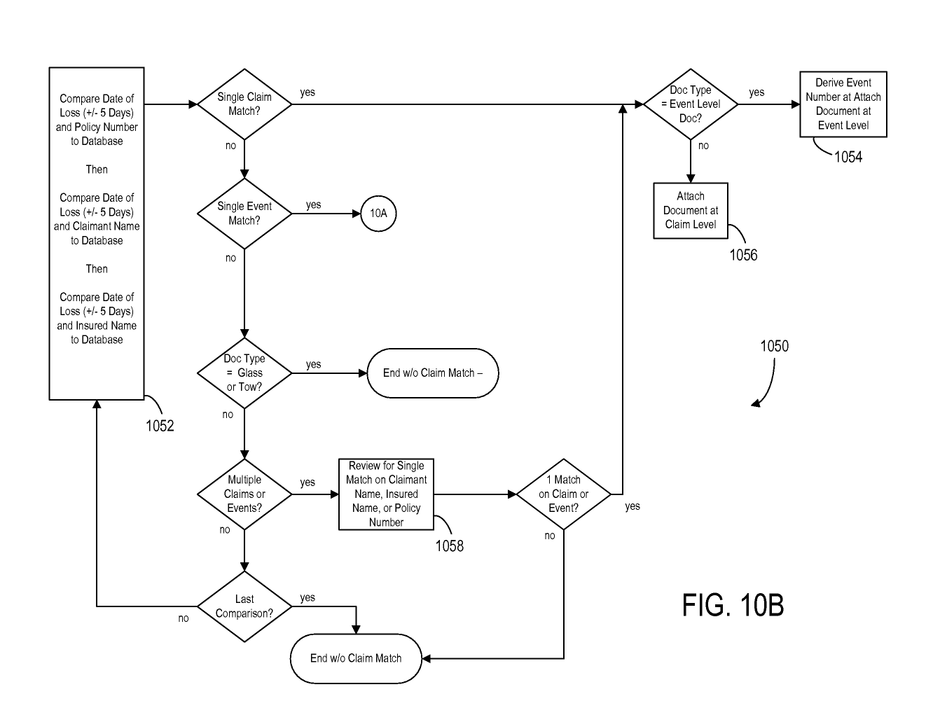

At 208, the document identification data is automatically matched to insurance information. Consider, for example, an insurance company that has issued a large number of insurance policies, and at least some of those insurance polices are associated with insurance events (e.g., automobile accidents). Moreover, at least some of the insurance events might be associated with a number of different insurance claims (e.g., when multiple people have been injured in a single accident). In this case, an automated computer-implemented matching engine might map a set of document identification data to an appropriate insurance claim identifier. Moreover, this mapping might be performed by applying the set of data to a pre-determined rule, formula, and/or a weight (e.g. one type of data might be considered a more likely indicator of an accurate claim number as compared to other types of data—and thus be “weighed” more heavily by the automated matching engine). Note that the insurance information might be temporarily or permanently stored (e.g., in connection with the document identification data and/or the document image). One example of such a matching system is described herein with respect to FIGS. 9, 10A, and 10B.

At 210, it is arranged to have the information provided for review. For example, an appropriate set of reviewers might be selected for a particular insurance document image. The communication addresses (e.g., email addresses) associated with those reviewers could then be determined, and the image may be transmitted to those addresses along with an insurance claim number suggested by the automated matching system. At 212, one or more insurance claims are then processed in accordance with the reviewed information.

FIG. 3 is a block diagram of a document conversion system 300 in accordance with some embodiments of the invention. As described with respect to FIG. 1, the document conversion system 300 may receive insurance documents from participants. For example, the document conversion system 300 might include an email server 312 to receive emails and attachments from participants. Similarly, the document conversion system 300 may include a web server 314 to access web sites or links and/or to receive information submitted via a web site associated with the system 300. According to some embodiments, the document conversion system 300 further includes one or more scanners 318 that can create electronic image files from paper documents.

According to some embodiments, the document conversion system 300 further includes an image converter 320. The image converter 320 might comprise, for example, an image format converter that translates data from a first image format to a second image format (e.g., a JPEG image to a bitmap image). The image converter 320 might also comprise, for example, an optical character recognition application that converts some or all of an image file into text information. Note that the image converter 320 might convert any type of document into any other type of document (e.g., a spreadsheet document might be converted to a word processing or HTML format).

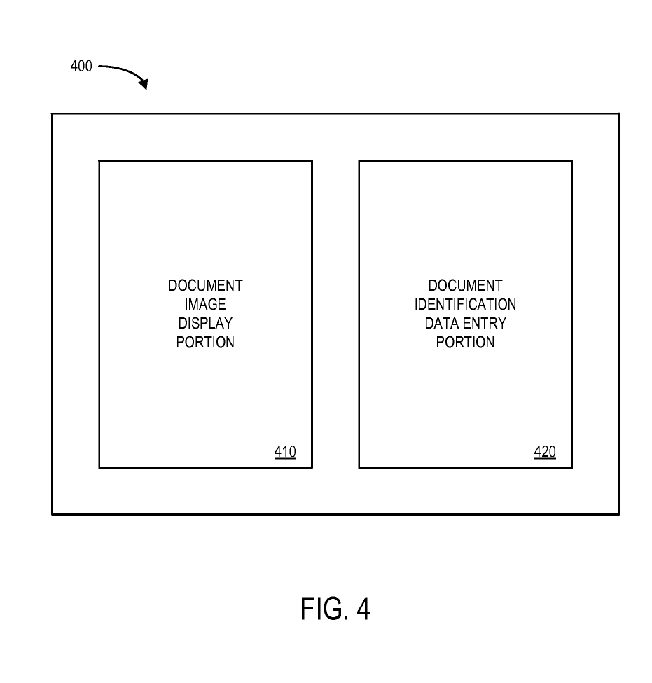

The document conversion system 300 may further include one or more identification data terminals 350. For example, operators sitting at such data terminals 350 might view images of documents and manually enter information to be associated with that document. Consider FIG. 4, which illustrates a document conversion system display 400 in accordance with some embodiments of the invention. In particular, the display includes document image display portion 410 that might display a picture representation of a received insurance document. The display may further include a document identification data entry portion 420 where the operator can manually enter information based his or her interpretation of the image display portion 410. By way of example only, the operator might enter in some or all of the following: date of loss information, an insured name, a claimant name, a claim location, and/or a claim type (e.g., automobile or life insurance). According to some embodiments, an operator might manually highlight an area of the image display portion 410 and indicate that information from that area should be automatically entered in the data entry portion (e.g., via an optical character recognition process).

The document conversion system 300 may further include one or more databases 350 to store the image information and associated identification data. Information from the databases 350 may then be transmitted to and/or accessed by other devices. For example, a scanned pdf image file in the database 350 (and a manually entered claimant name and address associated with that image file) might be transmitted to a remote automated matching engine.

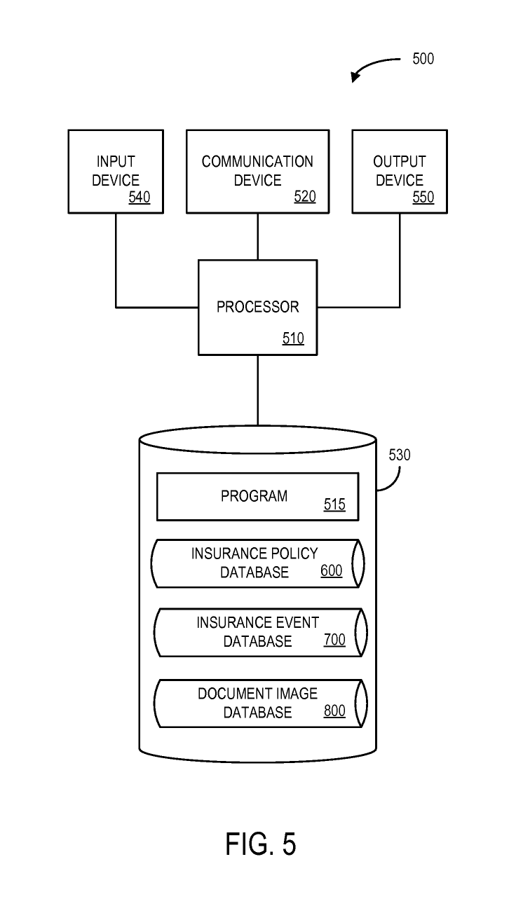

FIG. 5 illustrates an automated matching platform or engine 500 that might be descriptive, for example, of the engine 130 illustrated in FIG. 1 in accordance with an exemplary embodiment of the invention. The automated matching engine 500 comprises a processor 510, such as one or more INTEL® Pentium® processors, coupled to a communication device 520 configured to communicate via a communication network (not shown in FIG. 5). The communication device 520 may be used to communicate, for example, with one or more remote participant devices, document conversion systems, review systems, and/or claim processor devices.

The processor 510 is also in communication with an input device 540. The input device 540 may comprise, for example, a keyboard, a mouse, or computer media reader. Such an input device 540 may be used, for example, to enter information about document images and/or matching rules. The processor 510 is also in communication with an output device 550. The output device 550 may comprise, for example, a display screen or printer. Such an output device 550 may be used, for example, to provide reports and/or display information associate with matching rules (e.g. indicating how often a particular rule resulted in an accurate insurance claim number prediction).

The processor 510 is also in communication with a storage device 530. The storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 530 stores a program 515 for controlling the processor 510. The processor 510 performs instructions of the program 15, and thereby operates in accordance any embodiments of the present invention described herein. For example, the processor 510 may receive, via the communication device 520, an insurance document image and associated document identification data. The processor 510 may also match the document identification data with an insurance event identifier or an insurance claim identifier. Moreover, the processor 510 may match this information using one or more rules or formulas. According to some embodiments, the processor 510 may transmit, via the communication device 520, an indication of the insurance document image along with the insurance event or claim identifier for review and insurance claim processing.

As used herein, information may be “received” by or “transmitted” to, for example: (i) the automated matching engine 500 from participant devices, document conversion systems, review systems, and/or claim processor devices; or (ii) a software application or module within the automated matching engine 500 from another software application, module, or any other source.

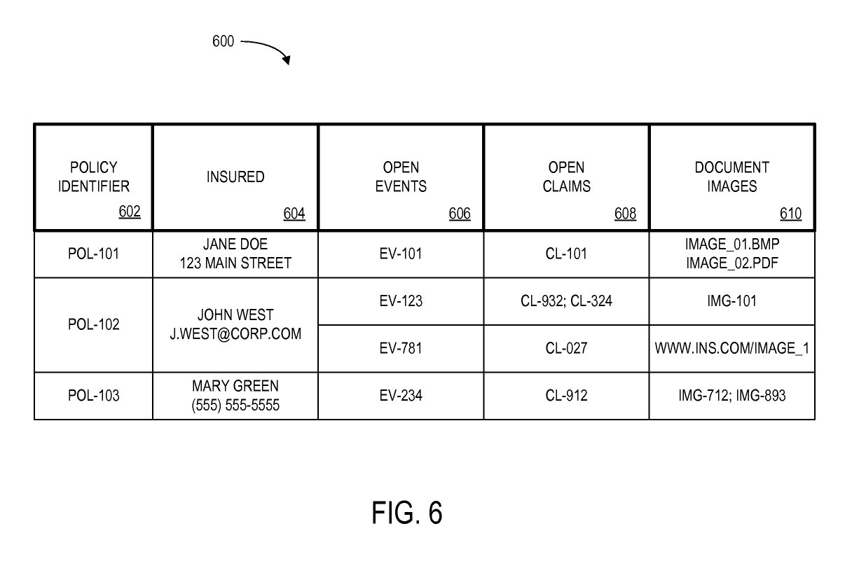

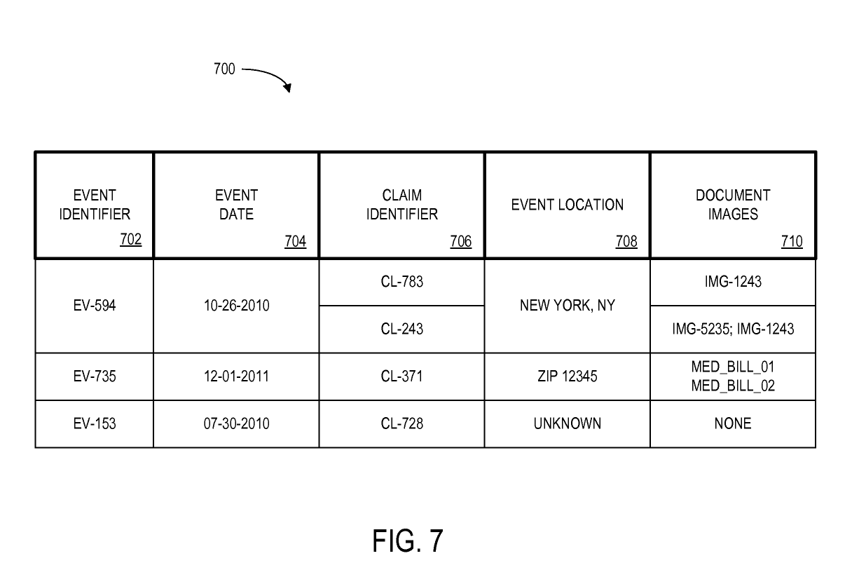

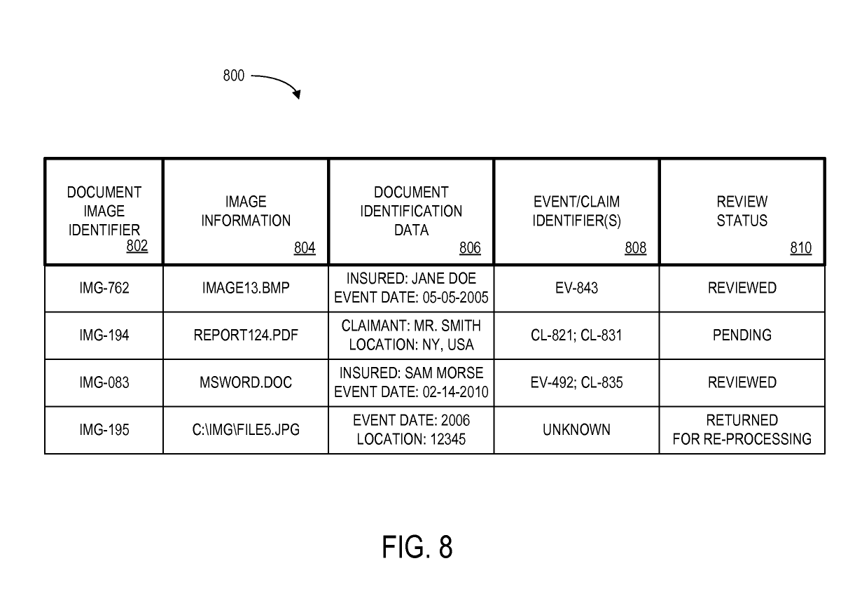

As shown in FIG. 5, the storage device 530 also stores: an insurance policy database 600 (described with respect to FIG. 6); an insurance event database 700 (described with respect to FIG. 7); and a document image database 800 (described with respect to FIG. 8). Examples of databases that may be used in connection with the automated matching engine 500 will now be described in detail with respect to FIGS. 6 through 8. The illustrations and accompanying descriptions of the databases presented herein are exemplary, and any number of other database arrangements could be employed besides those suggested by the figures.

FIG. 6 is a tabular view of an insurance policy database 600 in accordance with some embodiments of the present invention. The table includes entries identifying insurance policies that have been issued by an insurance company. The table also defines fields 602, 604, 606, 608, 610 for each of the entries. The fields specify: an insurance policy identifier 602, an insured 604, open events 606, open claims 608, and one or more document images 610. The information in the database 600 may be created and updated based on information received from insurance brokers, a document conversion system, and/or claim processor devices.

The insurance policy identifier 602 may be, for example, an alphanumeric code associated with an insurance policy, and the insured 604 may represent the name, address, and/or other information associated with that policy. The open events 606 may identify one or more insurance events that have occurred, and the open claims 608 may likewise identify one or more insurance claim that have been made, in connection with that policy. Note that multiple open events 606 might be associated with a single policy identifier 602 and multiple open claims 608 might be associated with a single open event 604.

The document images 610 may represent images of insurance documents that are associated with a particular policy identifier 602, open event 606, and/or open claim 608. The document images 610 may comprise, for example, an electronic file (e.g. a bitmap or pdf file), an identifier associated with another database, or a pointer to a particular location (e.g., on a network data server) where the image file is stored.

FIG. 7 is a tabular view of an insurance event database 700 in accordance with some embodiments of the present invention. The table includes entries identifying insurance events that have occurred in connection with an insurance policy. The table also defines fields 702, 704, 706, 708, 710 for each of the entries. The fields specify: an insurance event identifier 702, an event date 704, a claim identifier 706, an event location 708, and one or more document images 710. The information in the database 700 may be created and updated based on information received from a document conversion system and/or an automated matching engine.

The event identifier 702 may be, for example, an alphanumeric code associated with an insurance event and the event date 704 may indicate a date associated with that event (e.g., when the event occurred or when the first claim associated with that event was made). According to some embodiments, the event identifier 702 is based on, or associated with, the open events 606 in the insurance policy database 600.

The claim identifier 706 may be, for example, an alphanumeric code associated with claim that has been made in connection with the event identifier 702. According to some embodiments, the claim identifier 706 is based on, or associated with, the open claims 608 in the insurance policy database 600. The event location 708 may represent where an event occurred (e.g., an address or state where an automobile accident occurred).

The document images 710 may represent images of insurance documents that are associated with a particular event identifier 702. The document images 710 may comprise, for example, an electronic file (e.g., a bitmap or pdf file), an identifier associated with another database, or a pointer to a particular location (e.g. on a network data server) where the image file is stored.

FIG. 8 is a tabular view of a document image database 800 in accordance with some embodiments of the present invention. The table includes entries identifying insurance document images that are associated with insurance policies, events, and/or claims. The table also defines fields 802, 804, 806, 808, 810 for each of the entries. The fields specify: a document image identifier 802, image information 804, document identification data 806, one or more event/claim identifiers 808, and a review status 810. The information in the database 800 may be created and updated based on information received from a document conversion system, an automated matching engine, and/or claim processor devices.

The document image identifier 802 may be, for example, an alphanumeric code associated with a particular insurance document that has been received at a document conversion system. According to some embodiments, the document image identifier 802 is based on, or associated with, the document images 610 in the insurance policy database 600 and/or the document images 710 in the insurance event database 700.

The image information 804 may represent images of insurance documents and may comprise, for example, an electronic file (e.g., spreadsheet or word processing file), an identifier associated with another database, or a pointer to a particular location (e.g., a URL) where the image file is stored. The document identification data 806 may represent any set of data that is associated with that image. The document identification data 806 may be, for example, manually entered at the document conversion system based on an initial review of the received document.

The one or more event/claim identifiers 808 associated with document image with a particular insurance event and/or claim. The event/claim identifiers 808 might be, for example, automatically generated by a matching engine (e.g., based at least in part on the document identification data 806 associated with the image).

The review status 810 might indicate, according to some embodiments, whether or not the information in the document image database 800 has been reviewed and/or verified. Note that, in some embodiments, the review status 810 might indicate that the document conversion system should re-process the document image (e.g., by re-scanning a document and/or re-entering information about that document). For example, a reviewer might determine that some or all of the image information 804 is not legible.

According to some embodiments, information in the document image database 800 is associated with a document retention policy. For example, the document conversion system 120, the matching engine 130, the review system 104, and/or the claim processor devices 162 of FIG. 1 might automatically determine an appropriate document retention policy for the image information 804 based on what type of document it is, what type of insurance policy or claim is associated with the document, and/or the status of a claim. In accordance with the document retention policy, the imagine information 804 might be automatically deleted (e.g., after a pre-determined period of time associated with that policy) or saved (e.g., by preventing deletion or by moving a copy of the image information 804 to an electronic archive). According to some embodiments, a document retention message is displayed in connection with the document image information 804 (e.g. warning that a copy of the image information should not be altered or deleted).

FIG. 9 is a block diagram 900 illustrating how insurance data might be transmitted to reviewers in accordance with some embodiments of the present invention. In a particular, a matching system 910 may receive an insurance document image and associated document identification data from a document conversion system (e.g., via a communication device). The matching system might also match the document identification data with an insurance event identifier and/or an insurance claim identifier.

For example, the document identification data received by the matching system 910 might comprise a set of identification data (e.g., four separate pieces of data about a document image). In this case, the matching performed by the matching system 910 might be based on the set of data as applied to a pre-determined rule, formula, sequence (e.g., one type of data might be considered a more likely indicator of an accurate claim number as compared to other types of data—and thus be checked “first” by the matching system 910), and/or weight. In particular, the matching system 910 might attempt to identify an appropriate insurance policy, event, and/or claim number associated with an image.

According to some embodiments, the matching system 910 transmits an indication of the insurance document image (along with the automatically selected insurance event or claim identifier) via a communication device for review and/or insurance claim processing. For example, the matching system 910 might post an electronic message or notification to one or more review devices 920 (e.g., PC terminals associated with reviewers). According to some embodiments, the matching system 910 selects or otherwise determines at least one reviewer who will receive the document image. For example, the matching system 910 might use a routing policy or rule to select a set 922 of appropriate reviewers and/or review devices 920 based on a claim type and/or a geographic location associated with a claim. The matching system 910 may determine a set of communication addresses (e.g., email addresses) associated with that set 922 and use those addresses to transmit an indication of the document image along with the insurance event or claim identifier. The review devices 920 may the review, adjust, and/or annotate information as appropriate via a graphical user interface.

According to some embodiments, the review devices 920 are associated with claim processors who use a document image and associated information to handle an insurance claim. The review devices 920 may also be associated with a person who reviews document identification data and/or insurance information associated with a document image. In this case, the reviewer may provide an error indication when he or she determinates that some of the information is incorrect. Based on the error indication, the information may be re-determined or re-entered (e.g., by the reviewer or via the document conversion system 120 of FIG. 120).

Note that the matching system 910 might attempt to determine what insurance event or claim number should be associated with an image in any number of different ways. By way of example only, FIGS. 10A and 10B illustrate an automated matching method according to some embodiments of the present invention.

In particular, FIG 10A illustrates a claim matching method 1000 that might be used when at least one of a claim or event number is already associated with a document image. Note that if both a claim and event number are associated with a document (e.g., both were manually entered at a document conversion system), the claim number might be processed first (e.g., because it might usually represent the more reliable, accurate, and/or specific information).

At 1002, document data may be captured at a document conversion system, such as in any of the ways described herein with respect to FIG. 3. If a claim number is already associated with the document, the claim number may be compared to information in one or more database at 1004 (e.g., such as the insurance policy database 600 and/or insurance event database 700). If that particular claim number is not found, the process might continue as described with respect to FIG. 10B (e.g. as if no claim number was associated with the document image).

If the claim number was found, the event number may be determined for “event level” documents and attached to the image at 1006. If document is not “event level,” the claim number may be attached to the image at 1008.

If an event number was already initially associated with the document, the event number may be compared to information in one or more database at 1010 (e.g. such as the insurance policy database 600 and/or insurance event database 700). If that particular event number is not found, the process might continue as described with respect to FIG. 10B (e.g., as if no event number was associated with the document image).

If the event number was found, the event number may attached to the image for “event level” documents at 1012. Even if for non-event level documents, the event number may attached to the image if no claims currently exist for that event at 1014.

Assuming the event number does exist in a database, the document is not an “event level” document, and there are multiple claims associated with the event, it is determined whether or not information matches a single claim. If so, the image may be associated with that claim at 1016. If the information matches various claims with the same claim handler, the image may be associated with the first claim retrieved at 1020. If multiple handlers are involved, the image may be associated at the event level at 1018.

If multiple claims are not associated with the event and the information matches a single claim, the image may be associated with that claim at 1022. If the information matches multiple claims, the image may instead be associated at the event level at 1018.

FIG. 10B illustrates a claim matching method 1050 that might be used when neither a claim nor event number is already associated with a document image. At 1052, document identification data may be compared to information stored in one or more databases. Note that different pieces and/or combinations of the document identification data may be evaluated in sequence. For example, initially a date of loss (within a five day window) and policy number might be compared to the databases. Next, the date of loss (within a five day window) and a claimant name might compared to the databases. Finally, the date of loss (within a five day window) and an insured name might be compared to one or more databases.

In each case, if a single claim matches the information and the document type is “event level,” the event level is determined and associated with the image at 1054. For non-event level document types, the information is associated with the image at the claim level at 1056.

If a single event number is located for the document, the process can continue as described with respect to FIG. 10A Oust as if that event number was manually entered at the document conversion center). Note that some types of insurance claims might not be associated with any specific type of event (e.g., claims for automobile towing or windshield glass damage). In these cases, the process can simply end without specifying an event or claim number.

When multiple claims or events have been identified, a claimant name, insured name, or policy number may be reviewed to narrow the results. If one match is determined, the process can continue as describe with respect to elements 1054 and/or 1056 as appropriate. Moreover, when all of the document identification data set forth in element 1052 has been compared to information stored in the databases without success, the process ends without specifying an event or claim number.

After the appropriate policy, event, and/or claim numbers have been identified by the matching system, the information about a document image may be reviewed and/or used to process an insurance claim. According to some embodiments, these tasks may be accomplished using one or more graphical user interfaces.

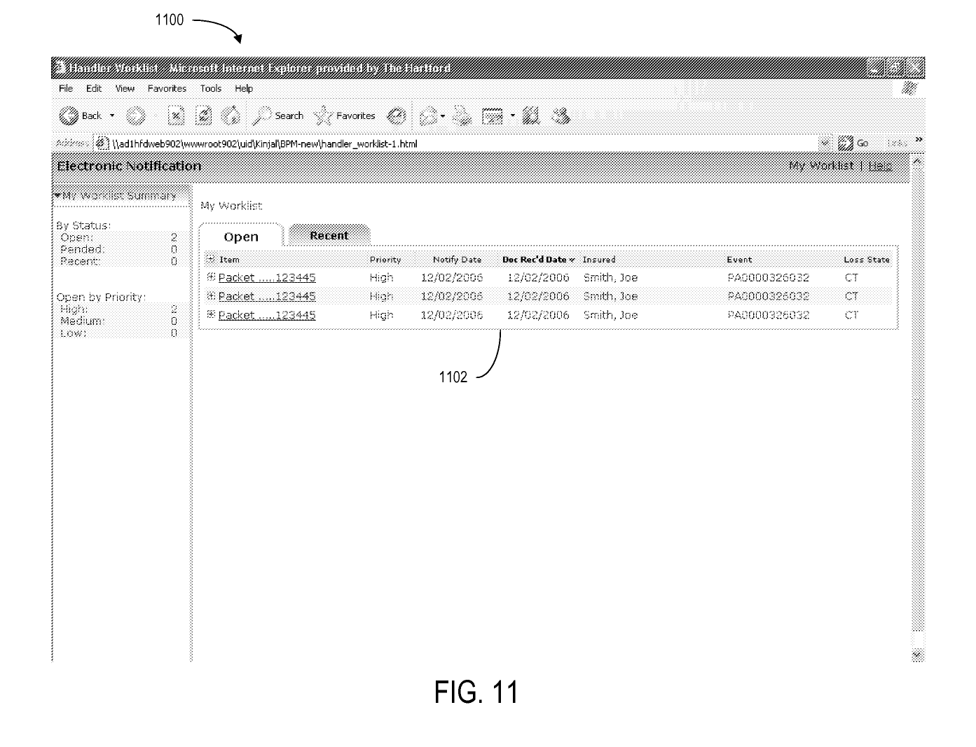

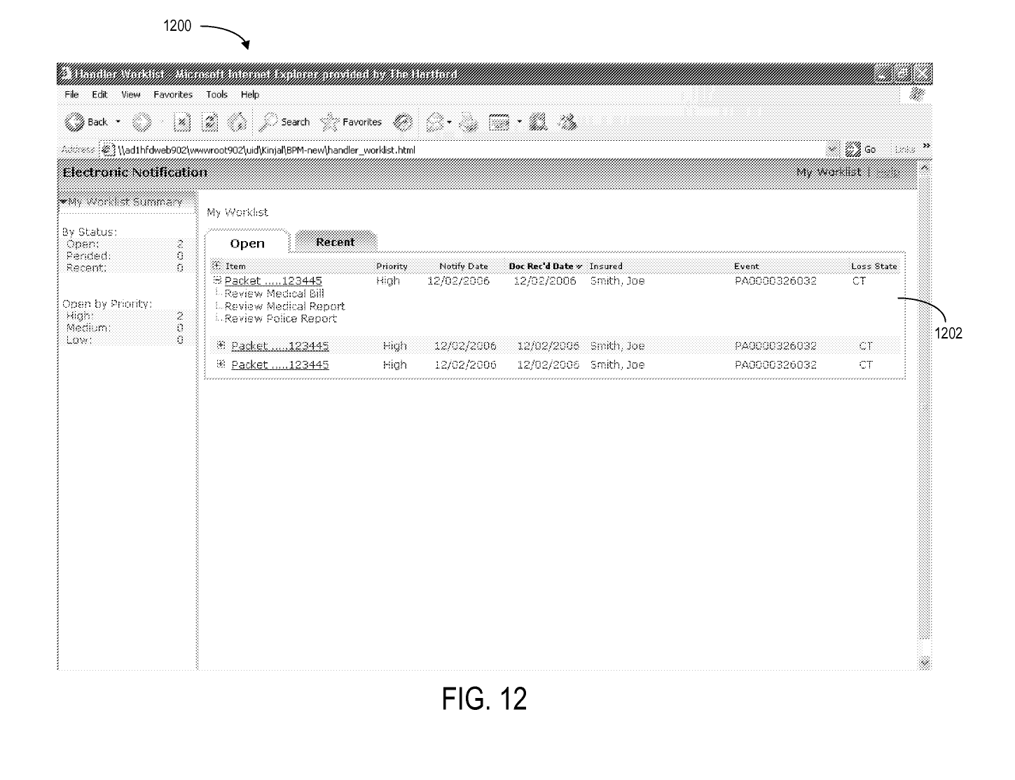

For example, FIGS. 11 through 17 illustrate some graphical user interface displays in accordance with an exemplary embodiment of the present invention. In particular, FIG. 11 illustrates a display 1100 that might be used, for example, to access document images and/or information about those images. The display 1100 includes a list 1102 of open document packets that have been received. The list 1102 indicates an item name (e.g., “packet . . . 12345”), a priority (e.g., “high” or “low”), a notification date, a document receipt date, an insured name, an event identifier, and geographic information (e.g., loss state) associated with each packet. The display 1100 might be associated with, for example, an individual's work list showing all new mail he or she has received (but not yet opened). Note that each packet in the list 1102 may represent one or more image documents. For example, FIG. 12 illustrates a display 1200 that might be provided after a user has selected or expanded a packet to show all of the distinct sub-documents 1202 (e.g., a medical bill, medial report, and police report).

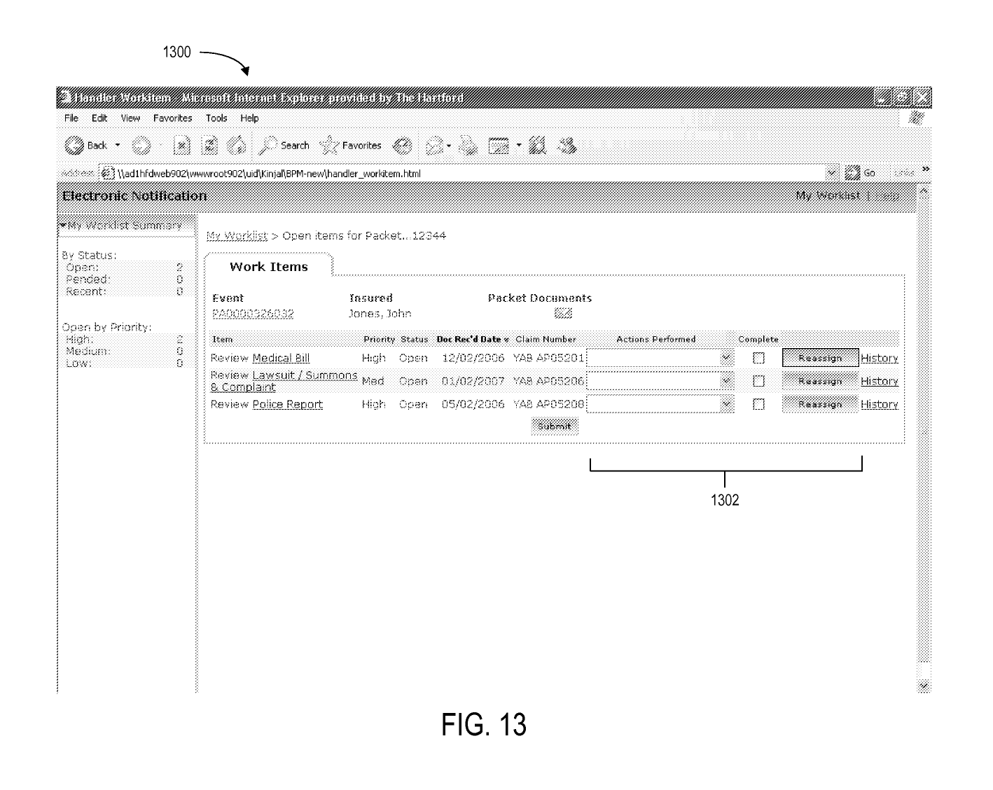

The user may, according to some embodiments, adjust and/or enter additional information about each of the sub-documents. For example, FIG. 13 illustrates a display 1300 that includes a user data input portion 1302 where he or she might enter “actions performed” for each document as well as an indication as to whether or not that action is complete. The display might further let the user submit the information and/or reassign document to someone else.

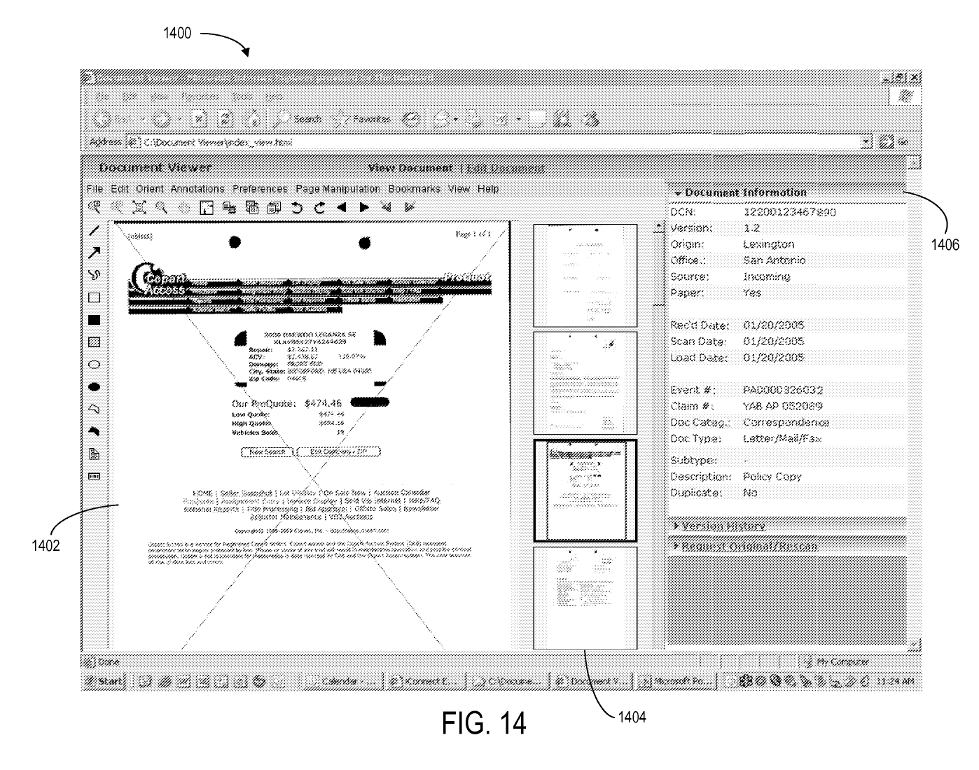

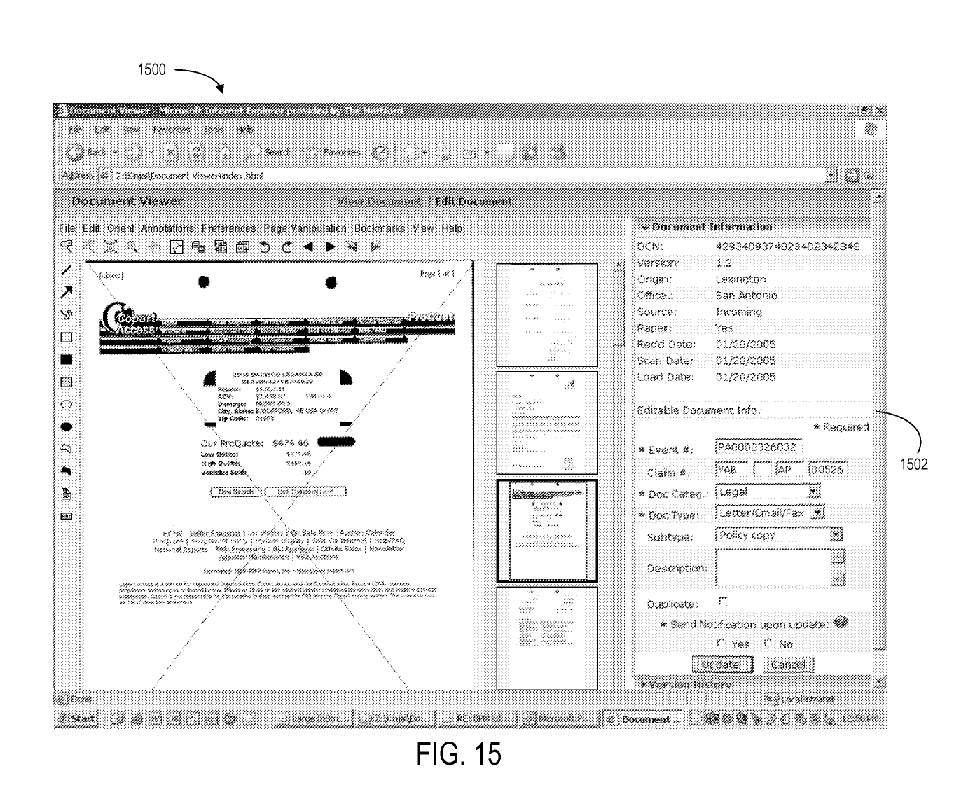

FIG. 14 illustrates a display 1400 that might be used, for example, to provide a view of a document 1402 to a user along with thumbnail views 1404 of other pages in that document and/or other documents in a packet. A “document information” display 1406 is also provided (e.g., including indications of the documents version, original, and date on which it was scanned). According to some embodiments, the user might access such an interface to modify and/or enter information about the document image. For example, FIG. 15 illustrates a display 1500 with a data entry portion 1502 where a user might enter or modify an event or claim number, a document type or subtype, and/or a description of the document. According to some embodiments, the version history associated with that document may also be provided, the user may request to receive the original copy of the document, and/or ask to have a file conversion system re-scan the document (e.g., because a portion of the image was inadvertently cut off during the initially scanning process).

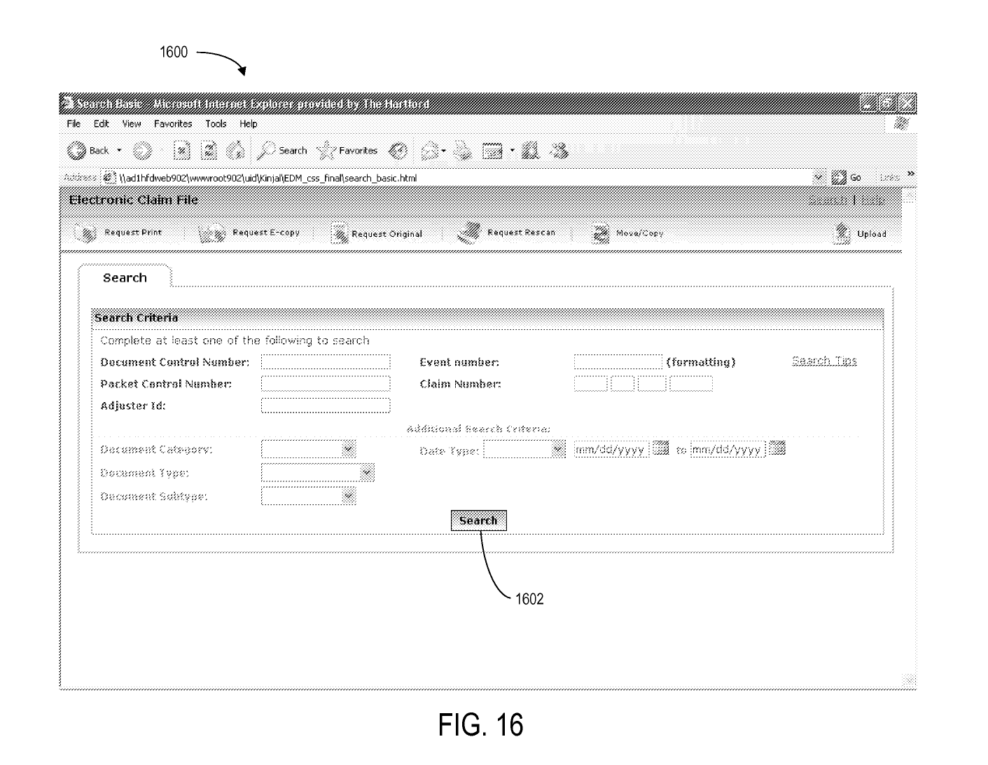

A user might also access a display to search for one or more document images of interest. For example, FIG. 16 illustrates a display 1600 that might be used to “search” 1602 for one or more document images based on a document control number, event number, claim number, and/or adjuster identifier.

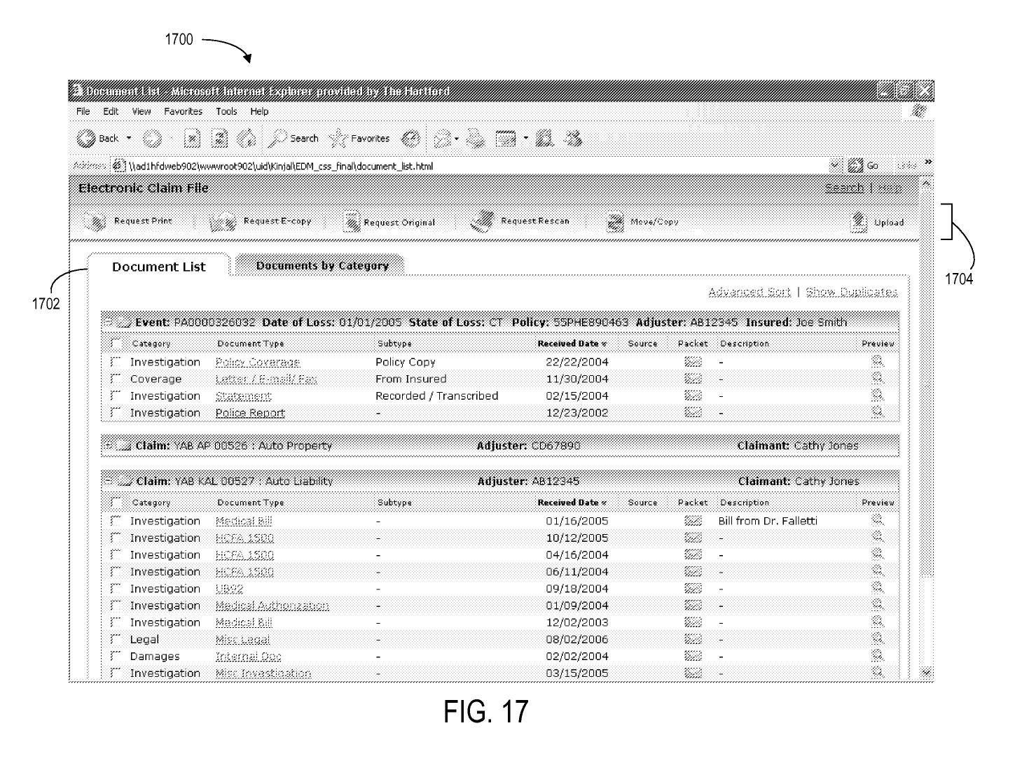

According to some embodiments, all document images associated with a particular policy, event, and/or claim might be displayed to a user. For example, FIG. 17 illustrates a display 1700 with a document list 1702 that presents all document images associated with a particular event identifier (along with the document images attached to claims under that event). For each image, the user may select to “preview” the image (e.g., by seeing the first page of the document in a pop-up display window).

The user may also, according to some embodiments, select one or more of the document images in the list 1702 (e.g., via selection boxes). Moreover, the user can, for the set of selected documents: “request print” to have the selected images printed; request electronic copy (“e-copy”) to have a file emailed to the user or another designee; “request original” to have the original paper copied delivered to his or her office; “request re-scan” to have the document conversion center re-scan, and/or re-enter information about, the document; “move/copy” to move or copy content from one claim to another (within the same or another event); and/or “upload” to add electronic content from the user's computer to the claim file.

In this manner, a system may be provided that allows incoming insurance documents to be converted to images and processed with an increased level of automation, accuracy and efficiency. Note that the automation may lower transaction costs and these savings might be shared by all parties (e.g., the insured and the insurer).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, not that any number of other configurations may be provided in accordance with embodiments of the present invention (e.g., some of the information associated with the databases described herein may be combined or stored in external systems). Moreover, although examples of specific types of claims involving automobile losses have been used, embodiments of the present invention could be used with other types of claims.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. An insurance document processing apparatus, comprising:
a communication device to receive and transmit information via a communication network;
a processor coupled to the communication device; and
a storage device in communication with said processor and storing instructions adapted to be executed by said processor to:
receive an insurance document image and associated document identification data from a document conversion system via the communication device,
match the document identification data with at least one of: (i) an insurance event identifier, or (ii) an insurance claim identifier, and
transmit an indication of the insurance document image along with the insurance event or claim identifier via the communication device for review and insurance claim processing.

2. The insurance document processing system of claim 1, wherein the insurance document is associated with one of a plurality of insurance policies, at least some of the insurance polices being associated with insurance events, and at least some of the insurance events are associated with a plurality of insurance claims, and further wherein said matching includes mapping the document identification data to an appropriate insurance claim identifier.

3. The insurance document processing system of claim 2, wherein the document identification data comprises a set of identification data, and said mapping is based on the set of data as applied to at least one of: (i) a pre-determined rule, (ii) a pre-determined formula, (iii) a pre-determined sequence, or (iv) a pre-determined weight.

4. The insurance document processing system of claim 1, further comprising:
a database to store at least one of: (i) an insurance policy database, (ii) an insurance event database, or (iii) a document image database.

5. The integrated claim processing system of claim 1, wherein said instructions are further adapted to be executed by said processor to:
select a set of addresses to receive the indication of the document image along with the insurance event or claim identifier.

6. An integrated insurance document processing system, comprising:
a document conversion system to: (i) receive an insurance document from a remote device, (ii) convert the received insurance document to a document image, and (iii) assign document identification data to the document image;
an automated matching engine to: (i) receive the document image and document identification data from the document conversion system, and (ii) match the document image with insurance information; and
a review system to: (i) receive the document image and the insurance information from the automated matching engine, and (ii) arrange for a manual review of the document image, the insurance information, or the document identification data.

7. The integrated insurance document processing system of claim 6, wherein said document conversion system further includes at least one of: (i) an email server, (ii) a web server, (iii) a facsimile machine, (iv) a facsimile machine, (v) an image format converter, (vi) an optical character recognition application, or (vii) an identification data terminal.

8. A computer-implemented method, comprising:
receiving an insurance document at a document conversion system;
converting, via the document conversion system, the received insurance document to a document image;
assigning document identification data to the document image;
automatically matching, via a computer-implemented process, the assigned document identification data to insurance information, storing an indication of the insurance information, and associating the insurance information with the document image;
arranging to provide the document image and the insurance information for review; and
subsequent to said review, processing an insurance claim in accordance with at least one of the document image, the insurance information, or the document identification data.

9. The computer-implemented method of claim 8, wherein the received insurance document is associated with at least one of: (i) a medical document, (ii) a law enforcement document, (iii) a billing document, (iv) a legal proceeding document, or (v) an insurance policy document.

10. The computer-implemented method of claim 8, wherein the received insurance document is a document packet that represents a plurality of sub-documents.

11. The computer-implemented method of claim 8, wherein said receiving comprises receiving the insurance document from a remote device via a communication network.

12. The computer-implemented method of claim 8, wherein said converting includes at least one of: (i) scanning a paper document, or (ii) translating from a first image format to a second image format.

13. The computer-implemented method of claim 8, wherein said assigning is performed at least one of: (i) manually via a graphical user interface, or (ii) using an optical character recognition process.

14. The computer-implemented method of claim 8, wherein said assigning is performed manually using a graphical user interface having a document image display portion and a document identification data entry portion.

15. The computer-implemented method of claim 8, wherein the document identification data includes at least one of: (i) date of loss information, (ii) an insured name, (iii) a claimant name, (iv) a claim location, (v) a claim type, (vi) an event number, (vii) a claim number, or (viii) an insurance policy number.

16. The computer-implemented method of claim 8, wherein the insurance information includes at least one of: (i) an insurance policy number, (ii) an insurance event number, or (iii) an insurance claim number.

17. The computer-implemented method of claim 8, wherein said arranging to provide the document image for review includes:
determining at least one reviewer to receive the document image;
transmitting the document image to at least one remote device associated with a determined reviewer; and
receiving annotated information from the remote device.

18. The computer-implemented method of claim 8, wherein the review is performed manually by a reviewer via a graphical user interface.

19. The computer-implemented method of claim 8, wherein at least one of said review and said claim processing is performed via a graphical user interface that includes at least one of: (i) an expandable document image list, (ii) a search function, (iii) an image view portion, (iv) thumbnail previews, or (v) a data entry portion.

20. The computer-implemented method of claim 8, wherein processing the insurance claim includes:
determining, based on a routing rule, at least one claim processor communication address to receive an indication associated with the document image.

21. The computer-implemented method of claim 8, wherein said arranging comprises:
displaying the document image to a reviewer along with at least one of the document identification data or the insurance information;
receiving from the reviewer an error indication associated with the displayed document image; and
re-determining at least one of the document identification data or the insurance information in response to the received error indication.

22. The computer-implemented method of claim 8, further comprising:
automatically associating the document image with at least one document retention policy.

23. The computer-implemented method of claim 22, further comprising:
in accordance with the document retention policy, automatically performing at least one of the following actions: (i) deleting the document image, (ii) saving the document image, or (iii) displaying a document retention message in connection with the document image.

24. A computer-readable medium storing instructions adapted to be executed by a processor to perform an insurance document processing method, said method comprising:
receiving an insurance document image and associated document identification data from a document conversion system via a communication device,
matching the document identification data with at least one of: (i) an insurance event identifier, or (ii) an insurance claim identifier, and
transmitting an indication of the insurance document image along with the insurance event or claim identifier via the communication device for review and insurance claim processing.

25. The computer-readable medium of claim 24, wherein execution of the instructions further results in:
determining at least one reviewer to receive the insurance document image;
transmitting the insurance document image to at least one remote device associated with a determined reviewer; and
receiving annotated information from the remote device.

26. The computer-readable medium of claims 25, wherein execution of the instructions further results in:
displaying the insurance document image to a reviewer along with at least one of (i) the matched insurance event identifier or (ii) the matched insurance claim identifier;
receiving from the reviewer an error indication associated with the displayed insurance document image; and
re-determining at least one of (i) the insurance event identifier or (ii) the insurance claim identifier in response to the received error indication.
